(19) United States
(12) Patent Application Publication
(10) Pub. No.: US 2020/0401264 A1
(43) Pub. Date: Dec. 24, 2020

(54) Method for generating tactile feedback and device performing same

(71) Applicant: AAC Technologies Pte. Ltd., Singapore City (SG)

(72) Inventors: Yulei Zhang, Shenzhen (CN); Jianqi Li, Shenzhen (CN); Xiuyue Wang, Shenzhen (CN)

(21) Appl. No.: 16/992,120

(22) Filed: Aug. 13, 2020

Related U.S. Application Data
(63) Continuation of application No. PCT/CN2019/092993, filed on Jun. 26, 2019.

(30) Foreign Application Priority Data
Jun. 24, 2019 (CN) 201910549307.X

(51) Int. Cl. G06F 3/041; G08B 6/00; G06F 3/0488

(52) U.S. Cl. CPC G06F 3/0416; G06F 3/04886; G08B 6/00

(57) ABSTRACT

The invention provides a method for generating tactile feedback. The method includes the steps of monitoring whether frictional force is generated on the surface of a preset touch assembly; when monitoring that the frictional force is generated on the surface of the touch assembly, acquiring frictional force data corresponding to the frictional force, then determining driving parameters of a preset motor according to the frictional force data and driving the motor according to the driving parameters. The invention further includes a device for performing the method described above. The user can perceive a motor vibration feedback from a finger or a palm during operation, and the probability of touch by mistake or repetitive operations of the user can be effectively reduced.

### FIELD OF THE PRESENT DISCLOSURE

The invention relates to the technical field of electronic devices, in particular to a method for generating tactile feedback, and to an electronic device for performing the method.

### DESCRIPTION OF RELATED ART

At present, fewer physical keys of an electronic device in the prior art have been gradually replaced with a touch screen and virtual keys. Through the use of the touch screen and the virtual keys, it is possible to provide a higher screen-to-body ratio to the electronic device, but the touch screen and the virtual keys do not perform timely feedback on a touch operation in an operation process, so that the probability of touch by mistake or repetitive operations of a user is increased.

### SUMMARY OF THE PRESENT INVENTION

A major object of the present invention is to provide a method for generating tactile feedback

For achieving the object described above, the present invention provides a method, comprising steps of:

monitoring whether frictional force is generated on the surface of a preset touch assembly or not;

acquiring frictional force data corresponding to the frictional force when the frictional force is detected on the surface of the touch assembly;

determining driving parameters of a preset motor according to the frictional force data and driving the motor according to the driving parameters.

Further, the touch assembly includes virtual keys, and when the number of the virtual keys is two or more, friction coefficients of the surfaces of various virtual keys are different; and

the step of monitoring whether the frictional force is generated on the surface of the preset touch assembly further includes a step of monitoring whether the frictional force is generated on the surfaces of the virtual keys.

Further, the touch assembly includes a touch panel; the step of monitoring whether the frictional force is generated on the surface of the preset touch assembly further includes a step of monitoring whether the frictional force is generated in a preset area on the surface of the touch pane.

Further, before the step of acquiring the frictional force data corresponding to the frictional force, further comprising steps of: determining a touch area of generating the frictional force on the touch panel and a touch command received by the touch area; and adjusting the friction coefficient of the touch area based on of a change of the touch command.

Further, the step of determining the driving parameters of the preset motor according to the frictional force data includes steps of: searching correspondence relationships between pre-established frictional force data samples and driving parameter samples of the motor; and determining the driving parameter samples of the motor corresponding to the frictional force data and determining the determined driving parameter samples of the motor as the driving parameters, wherein the frictional force data include a direction of the frictional force and a magnitude of the frictional force, and the driving parameters include vibration intensity and vibration waveform of the motor.

The present invention further provide a device for performing the method for generating tactile feedback, including:

a monitoring module used for monitoring whether frictional force is generated on the surface of a preset touch assembly;

an acquisition module used for, when monitoring that the frictional force is generated on the surface of the touch assembly, acquiring frictional force data corresponding to the frictional force; and

a driving module used for determining driving parameters of a preset motor according to the frictional force data and driving the motor according to the driving parameters.

Further, the touch assembly includes virtual keys, and when the number of the virtual keys is two or more, friction coefficients of the surfaces of various virtual keys are different; and the monitoring module is specifically used for monitoring whether the frictional force is generated on the surfaces of the virtual keys.

Further, the touch assembly includes a touch panel; and the monitoring module is specifically used for monitoring whether the frictional force is generated in a preset area on the surface of the touch panel.

Further, the device includes a position determining module used for determining a touch area of generating the frictional force on the touch panel and a touch command received by the touch area; and a friction coefficient adjusting module used for adjusting the friction coefficient of the touch area based on the change of the touch command.

Further, the driving module is further used for searching correspondence relationships between pre-established frictional force data samples and driving parameter samples of the motor; determining the driving parameter samples of the motor corresponding to the frictional force data and determining the determined driving parameter samples of the motor as the driving parameters; and wherein the frictional force data include a direction of the frictional force and the magnitude of the frictional force, and the driving parameters include a vibration intensity and vibration waveform of the motor.

By virtue of the method and device provided by the embodiment, when the user slides on the touch panel, the frictional force and motor vibration effect perceived by the user also change along with the change of the touch command. That is to say, the device can feed back different frictional force and vibrations for different touch operations of the user, so that the probability of touch by mistake or repetitive operations of the user can be effectively reduced.

### BRIEF DESCRIPTION OF THE DRAWINGS

Many aspects of the exemplary embodiments can be better understood with reference to the following drawings. The components in the drawing are not necessarily drawn to scale, the emphasis instead being placed upon clearly illustrating the principles of the present disclosure.

FIG. 1 is a flow diagram illustrating steps of a method for generating a tactile feedback in an embodiment of the invention.

FIG. 2 is an illustrative modular structure of a device for performing the method in FIG. 1.

FIG. 3 is an illustrative modular structure of a device in accordance with another embodiment of the present invention.

### DETAILED DESCRIPTION OF THE EXEMPLARY EMBODIMENTS

The present disclosure will hereinafter be described in detail with reference to several exemplary embodiments. To make the technical problems to be solved, technical solutions and beneficial effects of the present disclosure more apparent, the present disclosure is described in further detail together with the figure and the embodiments. It should be understood the specific embodiments described hereby is only to explain the disclosure, not intended to limit the disclosure.

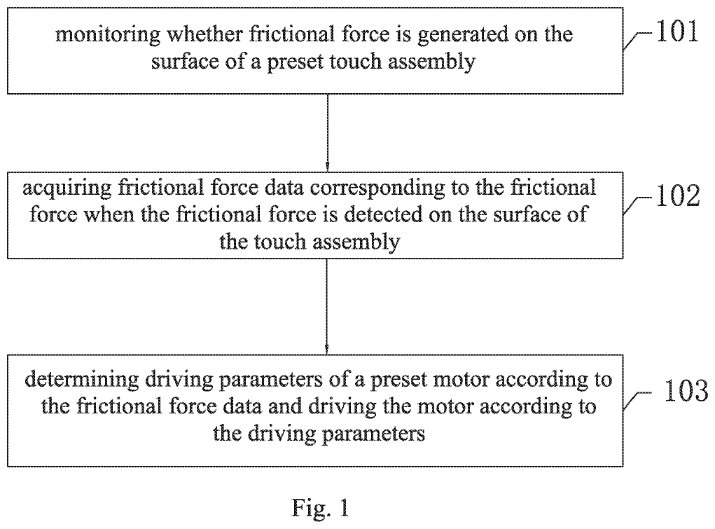

Referring to FIG. 1, FIG. 1 is a flow diagram illustrating steps of a method for generating tactile feedback in an embodiment of the invention. In the embodiment, the method of the tactile feedback includes the steps as follows.

Step 101, monitoring whether frictional force is generated on the surface of a preset touch assembly or not. The touch assembly can be one virtual key arranged on a display interface of a terminal device or on a housing of the terminal device, or can also be a touch display itself.

When being arranged on the housing of the terminal device, the virtual key can be positioned on a side surface, front surface or back surface of the housing of the terminal device. A material with a touch sensing function or a sensor can be adopted as the material of the virtual key. When the virtual key is arranged on the display interface of the terminal device, the virtual key can be arranged to suspend in one preset area on the interface of a screen in a certain shape or to display on a current interface in a form of an application icon.

A trigger signal can be sent out through touching, toggling or sliding the virtual key.

It will be understood that, when a user touches, toggles or slides the touch assembly, the frictional force is generated on the surface of the touch assembly, and the frictional force includes static frictional force and sliding frictional force, so that whether the user performs a touch operation on the touch assembly or not can be detected through monitoring whether the frictional force is generated on the surface of the touch assembly or not.

Step 102, when monitoring that the frictional force is generated on the surface of the touch assembly, acquiring frictional force data corresponding to the frictional force.

When monitoring that the frictional force is generated on the surface of the touch assembly, the user is performing the touch operation on the surface of the touch assembly, and meanwhile, the frictional force data corresponding to the frictional force can be acquired.

It will be understood that, when frictional force coefficients of different virtual keys or different touch areas in the touch assembly are different, the frictional force generated during touch operations of the user may be different, so that, through acquiring the frictional force data corresponding to the frictional force generated on the surface of the touch assembly, after analysis, the differentiation of the touch operations of the user can be facilitated, so as to generate different touch feedbacks.

Step 103, determining driving parameters of a preset motor according to the frictional force data and driving the motor according to the driving parameters.

After the frictional force data are acquired, the driving parameters corresponding to the preset motor can be determined according to the frictional force data. The motor can be a linear motor, an LRA (Linear Resonant Actuator) and the like. The frictional force data include a direction of the frictional force, a magnitude of the frictional force and the like, and the driving parameters include vibration intensity, vibration waveform and the like of the motor.

Frictional force data samples, such as the frictional force samples which are different in direction and different in magnitude can be predetermined, and then each frictional force data sample is correspondingly associated with one motor parameter sample separately. For example, the frictional force which slides along a preset X axis of the terminal device and of which the magnitude is 0.1N, a corresponding motor vibration frequency thereof is a; the frictional force which slides along the preset X axis of the terminal device and of which the magnitude is 0.2N, the corresponding motor vibration frequency thereof is b; and a is not equal to b. Correspondence relationships between the frictional force data samples and driving parameter samples of the motor are established and stored into the terminal device.

When the driving parameters of the preset motor are determined according to the frictional force data, through searching the stored correspondence relationships between the frictional force data samples and the driving parameter samples of the motor, the driving parameter samples of the motor corresponding to the frictional force data are determined, and then the determined driving parameter samples of the motor are determined as the driving parameters.

Specifically, when driven by different driving parameters, the motor will generate vibrations of different waveforms or different intensities, so as to perform feedbacks on the touch operations of the user in differentiated feedback ways.

The method for generating tactile feedback provided by the embodiment of the invention includes the steps of when monitoring that the frictional force is generated on the surface of the touch assembly, acquiring the frictional force data corresponding to the frictional force, then determining the driving parameters of the preset motor according to the frictional force data and driving the motor according to the driving parameters. That is to say, in the invention, when the user performs a touch or slide operation on the surface of the touch assembly, the touch or slide operation can drive the motor, so that the user can perceive a motor vibration feedback from a finger or a palm during operation, and the probability of touch by mistake or repetitive operations of the user can be effectively reduced.

Furthermore, based on the embodiment, the touch assembly specifically includes the virtual keys, and when the number of the virtual keys is two or more, the friction coefficients of the surfaces of various virtual keys are different.

Thus, step 101 of monitoring whether the frictional force is generated on the surface of the preset touch assembly or not specifically includes a step of monitoring whether the frictional force is generated on the surfaces of the virtual keys or not.

For ease of understanding, a mobile terminal is taken as an example in the embodiment. A mobile phone, serving as a typical mobile terminal, is generally provided with some keys, such as a switch key, a voice volume up key and a voice volume down key on the side surface of a body. At present, after a full screen is introduced, all smart device manufacturers want to replace side keys with the virtual keys. However, an operational error easily occurs because the virtual keys have no bump when being operated by the user, for example, the voice volume down key is touched by mistake when voice volume needs to be amplified.

In the embodiment, when the number of the virtual keys on the mobile terminal is two or more, the friction coefficients of the surfaces of various virtual keys are set as different values, for example, the surface of a voice volume up virtual key is set as a larger friction coefficient, and the surface of a voice volume down virtual key is set as a smaller friction coefficient. Thus, the user will perceive larger frictional force when touching the surface of the voice volume up virtual key, and perceive smaller frictional force when touching the surface of the voice volume down virtual key, thereby helping the user to distinguish various virtual keys.

Furthermore, in order to better help the user to distinguish various virtual keys, in the embodiment, the driving parameters of the preset motor can be determined through detecting the frictional force data generated on the surfaces of the virtual keys, and then the motor is driven to vibrate through the determined driving parameters, so as to feed back the touch operations to the user.

For example, the larger the frictional force is, the higher the vibration intensity of the motor is, thus, the user will perceive a larger sense of vibration when touching the surface of the voice volume up virtual key, and perceive a smaller sense of vibration when touching the surface of the voice volume down virtual key, thereby helping the user to better distinguish various virtual keys.

In addition, in the embodiment, the friction coefficient of the surface of a gap between the voice volume up virtual key and the voice volume down virtual key can also be set as a different coefficient value, and the coefficient value is different from the friction coefficients of the surfaces of the voice volume up virtual key and the voice volume down virtual key, so that, if the user perceives a transient change of the frictional force when performing operations back and forth between the voice volume up virtual key and the voice volume down virtual key, the touch has been converted into the voice volume down virtual key from the voice volume up virtual key or converted into the voice volume up virtual key from the voice volume down virtual key.

The method for generating tactile feedback provided by the embodiment includes the steps of, in the case the touch assembly includes the virtual keys, monitoring whether the frictional force is generated on the surfaces of the virtual keys or not; when monitoring that the frictional force is generated on the surfaces of the virtual keys, acquiring the frictional force data corresponding to the frictional force, then determining the driving parameters of the preset motor according to the frictional force data and driving the motor according to the driving parameters. When the number of the virtual keys is two or more, the friction coefficients of the surfaces of various virtual keys are different, so that the perceived frictional force and motor vibrations are different when the user touches different virtual keys, accordingly, it is possible to help the user to distinguish various virtual keys and the probability of touch by mistake or repetitive operations of the user can be effectively reduced.

Furthermore, based on the embodiment, the touch assembly specifically can also be a touch panel.

Therefore, the step 101 of monitoring whether the frictional force is generated on the surface of the preset touch assembly or not specifically includes a step of monitoring whether the frictional force is generated in the preset area on the surface of the touch panel or not.

For ease of understanding, a car central control panel is taken as an example in the embodiment. The existing car central control panel can complete most touch operations through the touch operation, for example, adjustment of temperature of an air conditioner can be achieved through sliding a temperature control bar or a temperature control roller in the car central control panel.

The method for generating tactile feedback in the embodiment includes the steps of firstly monitoring whether the frictional force is generated in the preset area on the surface of the touch panel or not, wherein the preset area is an area in which the temperature control bar or the temperature control roller is positioned; when monitoring that the frictional force is generated on the surface of the preset area, acquiring the frictional force data corresponding to the frictional force, then determining the driving parameters of the preset motor according to the frictional force data and driving the motor according to the driving parameters, so as to provide feedbacks to the user.

The frictional force of the preset area can be generated by a slide or drag operation of a finger of the user.

In the embodiment, when the user performs the slide or drag operation on the preset area on the surface of the touch panel, the touch panel can perform a real-time feedback on the touch operation of the user in a manner of driving the motor to vibrate, so that the probability of touch by mistake or repetitive operations of the user can be reduced.

Furthermore, after monitoring that the frictional force is generated in the preset area on the surface of the touch panel and before acquiring the frictional force data corresponding to the frictional force, the generation method further includes the following steps of:

determining a touch area of generating the frictional force on the touch panel and a touch command received by the touch area, and adjusting the friction coefficient of the touch area based on a change of the touch command.

For ease of understanding, the car central control panel is still taken as an example in the embodiment. Since the temperature control bar or the temperature control roller is generally formed by individual scales, when transformed from one scale into another scale, the operation can slide out of a desired temperature range if the user does not carefully view the scales, so that, at present, it is difficult for the user to determine the progress of touch adjustment in a touch adjustment process.

In the embodiment, the touch area of generating the frictional force on the touch panel and the touch command received by the touch area are determined, and then the friction coefficient of the touch area is adjusted based on the change of the touch command, so that the frictional force generated on the touch panel can change along with the change of the touch command, and the determined driving parameters of the motor also change accordingly. That is to say, the frictional force and motor vibration effect fed back to the user also synchronously change along with the change of the touch command.

For example, it is assumed that the temperature control bar includes five scales a, b, c, d and e, which respectively represent five different touch commands, and the friction coefficient corresponding to each scale is different. For example, the touch control bar indicates that the temperature is adjusted to w1° C. while sliding to the scale c from the scale b, and the friction coefficient of an area in which the finger of the user is positioned can be adjusted to k1 from k2 at this point; the touch control bar indicates that the temperature is adjusted to w3° C. from w2° C. while sliding to the scale d from the scale c, and the friction coefficient of the area in which the finger of the user is positioned can be adjusted to k2 from k1 at this point; the touch control bar indicates that the temperature is adjusted to w4° C. from w3° C. while sliding to the scale e from the scale d, and the friction coefficient of the area in which the finger of the user is positioned can be adjusted to k1 from k2 at this point; and k1 is not equal to k2.

In the embodiment, when the user slides to the scale e from the scale b, the change of the frictional force perceived by the user is F2→F1→F2→F1, wherein the frictional force F1 is obtained by calculating the friction coefficient k1 and the frictional force F2 is obtained by calculating the friction coefficient k2.

It will be understood that, in the above-mentioned way, when the user slides on the touch panel, the frictional force perceived by the user also changes along with the change of the touch command, and meanwhile, when the frictional force changes, the motor vibration effect perceived by the user also changes accordingly.

In addition, in the embodiment, the technologies, such as a reverse electrical vibration technology, a piezoelectric ceramic technology and an ultrasonic vibration technology can be adopted to adjust the friction coefficient of the touch area.

The reverse electrical vibration technology forms an oscillating electrostatic field around the skin through applying an imperceptible electrical signal to a whole body of the user when user uses the touch screen. When the finger of the user touches the touch screen, electrostatic force will change the friction coefficient between the finger and the screen.

The piezoelectric ceramic technology mainly converts electric energy into mechanical energy to change the friction coefficient through the vibration of the screen.

The ultrasonic vibration technology changes the friction coefficient between the touch screen and the finger of the user by using an ultrasonic vibration, and the ultrasonic vibration technology can make the touch screen provide a rough or smooth tactile experience.

It should be understood that the method for generating tactile feedback not only can be applied to the car central control panel, but also can be applied to any other terminal device with the touch panel, such as the mobile phone, a tablet computer, a smart watch, a smart television, a notebook computer or a game machine.

For the mobile phone, most game operations (such as up, down, left and right direction control, gun shooting, boxing, turning and acceleration) have been replaced with the virtual keys on the touch screen. Due to the limitation of the size of the screen, touch by mistake is easily generated by more keys and unclear boundaries of various keys. If adopting the method for generating tactile feedback provided by the embodiment, differentiated frictional force and motor vibrations can be fed back to the user according to changes of various operation commands, so that the user has a higher differentiation degree in operation.

For example, between switching actions of an upper key and a lower key, the frictional force can be used to remind the user of switching completion in combination with the motor vibrations. A rocker area can set different changes of the friction coefficient according to an angle of a rocker rotated by the user or a specific movement space on the screen or a distance to a rotation center of the rocker, and then utilizes the changes of the frictional force on the surface of the screen and the changes of the motor vibrations to simulate a boundary sense of edges of the keys and a damping sense of a material rod or the rocker and the like.

In the above-mentioned way, when the user slides on the touch panel, the frictional force and motor vibration effect perceived by the user also change along with the change of the touch command. That is to say, the embodiment can feed back different frictional force and vibrations for different touch operations of the user, so that the probability of touch by mistake or repetitive operations of the user can be effectively reduced.

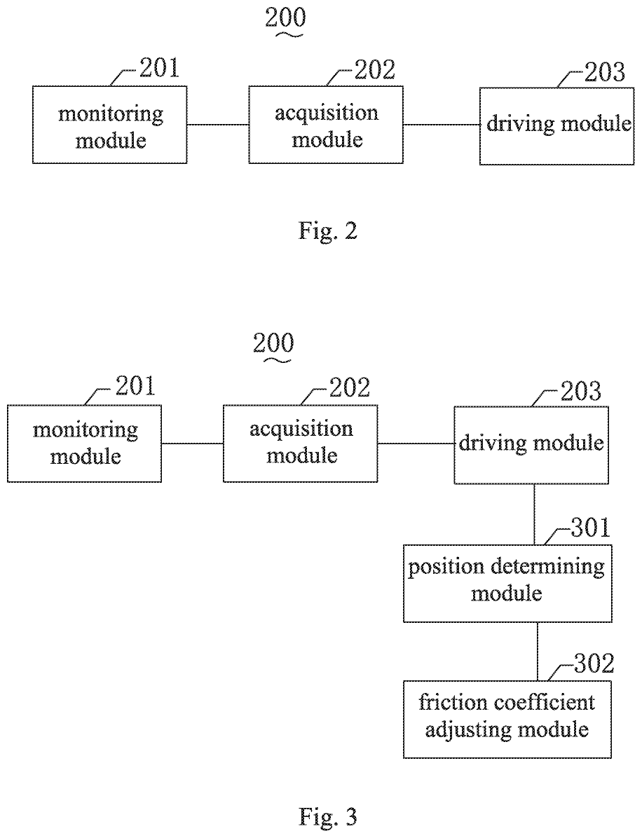

Furthermore, the invention further provides a device 200 for performing the method to generate a tactile feedback. Referring to FIG. 2, FIG. 2 is an illustrative modular structure of the device in the embodiment of the invention. In the embodiment, the device 200 of the tactile feedback includes:

a monitoring module 201 used for monitoring whether the frictional force is generated on the preset touch assembly or not;

an acquisition module 202 used for, when monitoring that the frictional force is generated on the surface of the touch assembly, acquiring frictional force data corresponding to the frictional force; and

a driving module 203 used for determining driving parameters of the preset motor according to the frictional force data and driving the motor according to the driving parameters.

The driving module 203 is further used for searching correspondence relationships between pre-established frictional force data samples and driving parameter samples of the motor; determining the driving parameter samples of the motor corresponding to the frictional force data and determining the determined driving parameter samples of the motor as the driving parameters, wherein the frictional force data include the direction of the frictional force and the magnitude of the frictional force, and the driving parameters include the vibration intensity and vibration waveform of the motor.

The device 200 for performing the method to generate tactile feedback provided by the embodiment is capable of, when monitoring that the frictional force is generated on the surface of the touch assembly, acquiring the frictional force data corresponding to the frictional force, then determining the driving parameters of the preset motor according to the frictional force data and driving the motor according to the driving parameters. That is to say, in the invention, when the user performs the touch or slide operation on the surface of the touch assembly, the touch or slide operation can drive the motor, so that the user can perceive the motor vibration feedback from the finger or the palm during operation, and the probability of touch by mistake or repetitive operations of the user can be effectively reduced.

Furthermore, based on the embodiment, the touch assembly includes the virtual keys, and when the number of the virtual keys is two or more, the friction coefficients of the surfaces of various virtual keys are different.

The monitoring module 201 is specifically used for monitoring whether the frictional force is generated on the surfaces of the virtual keys or not.

The device 200 provided by the embodiment is capable of, in the case the touch assembly includes the virtual keys, monitoring whether the frictional force is generated on the surfaces of the virtual keys or not; when monitoring that the frictional force is generated on the surfaces of the virtual keys, acquiring the frictional force data corresponding to the frictional force, then determining the driving parameters of the preset motor according to the frictional force data and driving the motor according to the driving parameters. When the number of the virtual keys is two or more, the friction coefficients of the surfaces of various virtual keys are different, so that the perceived frictional force and motor vibrations are different when the user touches different virtual keys, accordingly, it is possible to help the user to distinguish various virtual keys and the probability of touch by mistake or repetitive operations of the user can be effectively reduced.

Furthermore, when the touch assembly includes the touch panel, the monitoring module 201 is specifically used for monitoring whether the frictional force is generated in the preset area on the surface of the touch panel or not.

According to the device 200 provided by the embodiment, when the user performs the slide or drag operation on the preset area on the surface of the touch panel, the touch panel can perform real-time feedback on the operations of the user in a manner of driving the motor to vibrate, so that the probability of touch by mistake or repetitive operations of the user can be reduced.

Furthermore, referring to FIG. 3, FIG. 3 is another illustrative modular structure of a device for performing the method to generate tactile feedback. In the embodiment, the device 200 of the tactile feedback includes:

a monitoring module 201 used for monitoring whether the frictional force is generated on the preset touch assembly or not;

an acquisition module 202 used for, when monitoring that the frictional force is generated on the surface of the touch assembly, acquiring the frictional force data corresponding to the frictional force;

a driving module 203 used for determining the driving parameters of the preset motor according to the frictional force data and driving the motor according to the driving parameters;

a position determining module 301 used for determining a touch area of generating the frictional force on the touch panel and a touch command received by the touch area; and

a friction coefficient adjusting module 302 used for adjusting the friction coefficient of the touch area based on the change of the touch command.

According to the device 200 provided by the embodiment, when the user slides on the touch panel, the frictional force and motor vibration effect perceived by the user also change along with the change of the touch command. That is to say, the embodiment can feed back different frictional force and vibrations for different touch operations of the user, so that the probability of touch by mistake or repetitive operations of the user can be effectively reduced.

It should be understood, an implementation principle of the device 200 is consistent with that of the method for generating tactile feedback, so that a specific implementation mode of the device 200 can refer to implementation modes described in various embodiments in the method for generating tactile feedback, and is not described here again.

It should be understood that the embodiments provided by the invention are merely illustrative. For example, division of various modules is merely one logic function division, and additional division modes can be provided during actual implementation. A plurality of modules or assemblies can be combined or integrated into another system, or some features can be ignored or not performed. Moreover, the displayed or discussed interconnections can be implemented through some interfaces, and indirect coupling or communication connection between the devices or the modules can be in an electrical form, a mechanical form or other forms. The modules described as separate components may or may not be physically separated; and the components as the modules may or may not be physical modules, can be positioned in one place, or can also be distributed on a plurality of network modules. Part or all of the modules can be selected according to the actual requirements to achieve objectives of the embodiment.

In addition, various function modules in various embodiments of the invention can be integrated into one processing module and can also be individually represented physically, and two or more modules can be integrated into one module. The integrated modules can be implemented by adopting a form of hardware, and can also be implemented by adopting a form of a software function module.

The integrated modules can be stored into a computer readable storage medium if being implemented in the form of the software function module and sold or used as an independent product. Based on such understanding, the spirit of the technical solutions of the application, or a part thereof making a contribution to the prior art, or all or part of the technical solutions can be embodied in a form of a software product. The computer software product is stored into one storage medium, wherein the storage medium includes any medium capable of storing program codes, such as a U disk, a mobile hard disk, a read-only memory (ROM), a random access memory (RAM), a magnetic disk or a CD-ROM.

It should be noted that, for the embodiments corresponding to the method for generating tactile feedback, for simple description, the embodiments are described as a series of action combinations, but those skilled in the art should acquire that, the invention is not limited by the described action sequence, because according to the invention, some steps may be performed in other orders or performed simultaneously. Secondly, those skilled in the art should also acquire that, the embodiments described in the specification all belong to preferred embodiments, and the involved steps and modules are not necessary for the application.

It is to be understood, however, that even though numerous characteristics and advantages of the present exemplary embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms where the appended claims are expressed.

What is claimed is:

1. A method for generating tactile feedback, comprising steps of:
monitoring whether frictional force is generated on the surface of a preset touch assembly;
acquiring frictional force data corresponding to the frictional force when the frictional force is detected on the surface of the touch assembly;
determining driving parameters of a preset motor according to the frictional force data and driving the motor according to the driving parameters.

2. The method for generating tactile feedback as described in claim 1, wherein the touch assembly includes virtual keys, and when the number of the virtual keys is two or more, friction coefficients of the surfaces of various virtual keys are different; and
the step of monitoring whether the frictional force is generated on the surface of the preset touch assembly further includes a step of monitoring whether the frictional force is generated on the surfaces of the virtual keys.

3. The method for generating tactile feedback as described in claim 1, wherein the touch assembly includes a touch panel;
the step of monitoring whether the frictional force is generated on the surface of the preset touch assembly further includes a step of
monitoring whether the frictional force is generated in a preset area on the surface of the touch pane.

4. The method for generating tactile feedback as described in claim 3, wherein, before the step of acquiring the frictional force data corresponding to the frictional force, further comprising steps of:
determining a touch area of generating the frictional force on the touch panel and a touch command received by the touch area; and
adjusting the friction coefficient of the touch area based on of a change of the touch command.

5. The method for generating tactile feedback as described in claim 1, wherein the step of determining the driving parameters of the preset motor according to the frictional force data includes steps of:
searching correspondence relationships between pre-established frictional force data samples and driving parameter samples of the motor; and
determining the driving parameter samples of the motor corresponding to the frictional force data and determining the determined driving parameter samples of the motor as the driving parameters, wherein the frictional force data include a direction of the frictional force and a magnitude of the frictional force, and the driving parameters include vibration intensity and vibration waveform of the motor.

6. The method for generating tactile feedback as described in claim 2, wherein the step of determining the driving parameters of the preset motor according to the frictional force data includes steps of:
searching correspondence relationships between pre-established frictional force data samples and driving parameter samples of the motor; and
determining the driving parameter samples of the motor corresponding to the frictional force data and determining the determined driving parameter samples of the motor as the driving parameters, wherein the frictional force data include a direction of the frictional force and a magnitude of the frictional force, and the driving parameters include vibration intensity and vibration waveform of the motor.

7. The method for generating tactile feedback as described in claim 3, wherein the step of determining the driving parameters of the preset motor according to the frictional force data includes steps of:
searching correspondence relationships between pre-established frictional force data samples and driving parameter samples of the motor; and
determining the driving parameter samples of the motor corresponding to the frictional force data and determining the determined driving parameter samples of the motor as the driving parameters, wherein the frictional force data include a direction of the frictional force and a magnitude of the frictional force, and the driving parameters include vibration intensity and vibration waveform of the motor.

8. The method for generating tactile feedback as described in claim 4, wherein the step of determining the driving parameters of the preset motor according to the frictional force data includes steps of:
searching correspondence relationships between pre-established frictional force data samples and driving parameter samples of the motor; and
determining the driving parameter samples of the motor corresponding to the frictional force data and determining the determined driving parameter samples of the motor as the driving parameters, wherein the frictional force data include a direction of the frictional force and a magnitude of the frictional force, and the driving parameters include vibration intensity and vibration waveform of the motor.

9. A device for performing a method for generating tactile feedback, including:
a monitoring module used for monitoring whether frictional force is generated on the surface of a preset touch assembly;
an acquisition module used for, when monitoring that the frictional force is generated on the surface of the touch assembly, acquiring frictional force data corresponding to the frictional force; and
a driving module used for determining driving parameters of a preset motor according to the frictional force data and driving the motor according to the driving parameters.

10. The device as described in claim 9, wherein the touch assembly includes virtual keys, and when the number of the virtual keys is two or more, friction coefficients of the surfaces of various virtual keys are different; and the monitoring module is specifically used for monitoring whether the frictional force is generated on the surfaces of the virtual keys.

11. The device as described in claim 9, wherein the touch assembly includes a touch panel; and the monitoring module is specifically used for monitoring whether the frictional force is generated in a preset area on the surface of the touch panel.

12. The device as described in claim 11, further comprising:
a position determining module used for determining a touch area of generating the frictional force on the touch panel and a touch command received by the touch area; and
a friction coefficient adjusting module used for adjusting the friction coefficient of the touch area based on the change of the touch command.

13. The device as described in claim 9, wherein the driving module is further used for searching correspondence relationships between pre-established frictional force data samples and driving parameter samples of the motor; determining the driving parameter samples of the motor corresponding to the frictional force data and determining the determined driving parameter samples of the motor as the driving parameters; and wherein
the frictional force data include a direction of the frictional force and the magnitude of the frictional force, and the driving parameters include a vibration intensity and vibration waveform of the motor.

14. The device as described in claim 10, wherein the driving module is further used for searching correspondence relationships between pre-established frictional force data samples and driving parameter samples of the motor; determining the driving parameter samples of the motor corresponding to the frictional force data and determining the determined driving parameter samples of the motor as the driving parameters; and wherein
the frictional force data include a direction of the frictional force and the magnitude of the frictional force, and the driving parameters include a vibration intensity and vibration waveform of the motor.

15. The device as described in claim 11, wherein the driving module is further used for searching correspondence relationships between pre-established frictional force data samples and driving parameter samples of the motor; determining the driving parameter samples of the motor corresponding to the frictional force data and determining the determined driving parameter samples of the motor as the driving parameters; and wherein
the frictional force data include a direction of the frictional force and the magnitude of the frictional force, and the driving parameters include a vibration intensity and vibration waveform of the motor.

16. The device as described in claim 12, wherein the driving module is further used for searching correspondence relationships between pre-established frictional force data samples and driving parameter samples of the motor; determining the driving parameter samples of the motor corresponding to the frictional force data and determining the determined driving parameter samples of the motor as the driving parameters; and wherein
the frictional force data include a direction of the frictional force and the magnitude of the frictional force, and the driving parameters include a vibration intensity and vibration waveform of the motor.
